(19) United States
(12) Patent Application Publication
(10) Pub. No.: US 2006/0114572 A1
(43) Pub. Date: Jun. 1, 2006

(54) Optical radiation generation apparatus and method

(75) Inventor: Christoph Bittner, Herts (GB)

Correspondence Address: SUGHRUE MION, PLLC, 2100 PENNSYLVANIA AVENUE, N.W., SUITE 800, WASHINGTON, DC, 20037, US

(73) Assignee: FUJIFILM ELECTRONIC IMAGING LTD., Herts (GB)

(21) Appl. No.: 11/001,946

(22) Filed: Dec. 1, 2004

(51) Int. Cl. G02B 27/30

(52) U.S. Cl. 359/641

(57) ABSTRACT

A radiation generating apparatus includes an emitter bar having an array of optical radiation emitters arranged along a line, each emitter causing optical radiation to be emitted in substantially a common direction. The apparatus also includes one or more lenses, positioned adjacent the emitters, so as to collimate the radiation emitted from each emitter and to generate a line of substantially parallel light beams. Each beam is collimated in at least a cross-array direction substantially perpendicular to the plane defined by the line of emitters and the common direction, such that any relative positional deviations from linearity for the light beams in the cross-array direction with respect to their width in that direction, is smaller downstream of the lens(es) with respect to that at the emitters.

### FIELD OF THE INVENTION

The present invention relates to optical radiation generation apparatus, for example for use in the printing and photographic industries in the field of thermal imaging and printing. The invention also extends to methods of producing such apparatus.

### BACKGROUND OF THE INVENTION

In many printing applications, and in particular for thermal printing, it is known to use radiation sources which comprise an array of radiation emitters arranged along a line, this line being typically about 10 mm long. The radiation from such emitters is normally within the optical or infra-red wavebands. Such emitters typically produce diverging radiation beams which are processed by optical apparatus downstream of the emitted beams so as to produce either a line of radiation of uniform intensity (due to lateral scan overlap) or a series of spots, each spot corresponding to a particular emitter. One example of such a device is a “laser bar”. Here, each emitter has a typical aperture of 1 micron high by about 100-150 microns wide at a pitch of 200-250 microns, depending on the “fill factor”. The laser aperture leads to an asymmetrical beam profile with typical divergence in the fast axis of 30 degrees and 10 degrees in the slow axis. The fast axis is that lying perpendicular to the line of emitters, whereas the slow axis is that parallel to the line of emitters.

All laser bars possess some level of deviation from straightness in the “cross-array” direction, that is they exhibit positional deviations on the fast axis. The magnitude of these positional errors can easily exceed 2 to 3 microns. This feature is commonly known as “smile”. The shape of these deviations can range from a simple bend to a multiple S-shape, and the magnitude varies from laser bar to laser bar. If a number of such bars are stacked into an array, each bar will exhibit different smile characteristics.

A typical application for a laser bar will involve re-imaging the near-field pattern in the fast axis direction to form a line or array of dots. Many printing applications, require a row of diffraction limited spots accurately aligned along a straight line. Any deviation from a perfect straight line will appear as a defect in the printed image. Other applications require a narrow line of radiation to illuminate a waveguide, SLM (Spatial Light Modulator), DMD (Digital Micromirror Device) and so on. In this case the coupling efficiency with such devices can be degraded or the non-uniformities in the output light will be seen if the illumination line is not diffraction limited and straight. Typically the spots or lines being formed from a laser bar will have dimensions in the range 10 to 50 microns. Thus, importantly the emitter aperture will be magnified by a factor of 10 to 50 times. Unfortunately, this will also magnify the size of the smile deviation. Thus the error in spot or line position may be of the same order as the spot or line width. In many applications this level of deviation is unacceptable, leading to intensity and/or coupling variations. Thus a correction technique is required.

FIG. 1 shows the typical prior art optical arrangement in the cross-array direction (the line of emitters being into the plane of the figure) used to form a line or an array of spots from a laser bar emitter. Two radiation sources S1 and S2 are shown displaced by a deviation distance D1. The radiation is highly divergent and is collimated by lens L1 having a focal length F₁. The two collimated beams exhibit an angular displacement after L1. The beams are re-imaged by a second lens L2 (of focal length F₂) to form a line or a line of spots. The two displaced sources are thereby imaged to the two images I1 and I2, displaced by a distance D2. The ratio of distance D1 to D2 is given by the lateral magnification of the system, which is determined by the size of the line or spots required at the output.

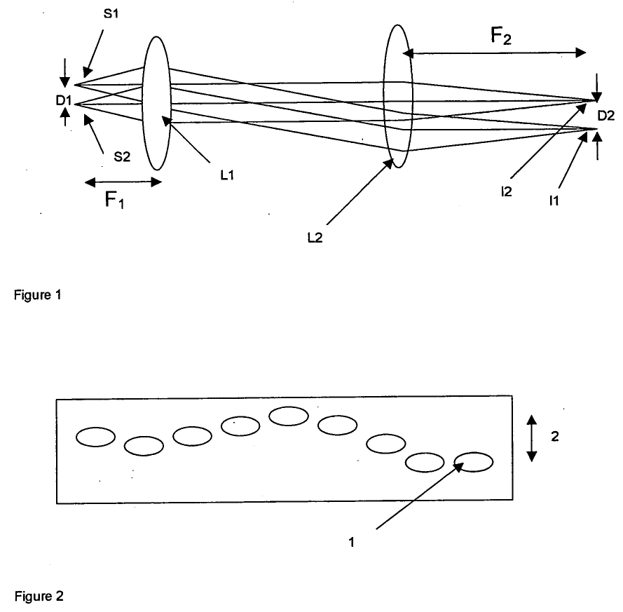

FIG. 2 shows a typical laser bar output exhibiting non-uniformities in the cross-array direction. The ellipse 1 is a representation of the near-field pattern from a single emitter measured a small distance from the laser facet. As can be seen the height of these emitters varies (arrow 2) across the length of the bar. With up to 40 emitters per bar the non-straightness can take a complex shape, but this is typically smoothly varying. The dimension 2 can be up to 5-6 microns in the worst case, but is more typically 2-3 microns in a well designed laser bar.

The typical depth of a waveguide downstream of lens L2 is in the range 10 to 20 microns. Thus the emitter aperture will be magnified by a factor of 10 to 20 times, and the smile deviation will be magnified by the same amount. The error in spot or line position will be of the same order as the spot or line width.

Another feature of laser diode bars is that it is common for one isolated emitter to produce little or no light. Therefore for line sources, the coupling optics must mix the emitted light sufficiently that the beam illuminating the waveguide is still relatively uniform. If the beam is extremely non-uniform this would have to be corrected by an array of modulators, which would reduce the overall efficiency of the system.

Previous work in this area has mainly concentrated on modifying the converging beams after the field lens L2. U.S. Pat. No. 5,854,651 shows the beam being deflected by an array of parallel lens plates. This technique will introduce spherical aberration as the beam passing through the plates is convergent. This will also increase the wings seen on a focus line or spot, which will be disadvantageous in most applications. This technique will not work in the collimated section of the beam as the angle of the beams are unaffected by tilting a parallel plate.

U.S. Pat. No. 5,629,791 shows a correction technique using mirrors being adjusted in the beam direction or tilted about a hinge point some distance from the mirror. Moving the lens along the beam path will introduce path errors leading to focus errors, which, if small spot sizes are required, will be unacceptable. Tilting the lens about a point remote from the centre of the lens will introduce a tilt and translation of the beam at the same time. This displacement will also cause path errors.

An alternative method, shown in U.S. Pat. No. 5,864,651 and U.S. Pat. No. 5,861,992 is to displace lens L1 as a single lens unit or as an array of lenslets in the cross-array direction to produce an array of collimated parallel beams. This technique will correct the beam but at the expense of moving the lens off-axis and introducing significant aberrations. Also since the lens being adjusted is collimating a high numerical aperture (NA) divergent beam, there will be little tolerance of mechanical or optical errors. This makes this approach difficult to assemble. U.S. Pat. No. 6,166,759 shows a related design for deforming a long cylindrical lens to match the emitter non-straightness.

It is an object of the present invention to provide correction of cross-array non-straightness errors of the emitters so that the beams emerging from the assembly are parallel and collimated. This will allow the collimated beam to be focused down to a single diffraction limited line or line of diffraction limited spots.

It is another object of this present invention to provide for correction of the emitter non-straightness errors in a simple mechanical assembly, or a single optical element, thus making the assembly compact and transferable to an array of laser bars.

It is another objective of the invention to provide uniform illumination across the length of a waveguide, and to be tolerant of a single emitter failing on the laser bar.

It is another objective of this design to maximize the coupling between the laser and output beam, by matching the NA of the laser to the NA of the waveguide structure.

### SUMMARY OF THE INVENTION

In accordance with a first aspect of the present invention, an optical radiation generation apparatus comprises:

an emitter bar comprising an array of optical radiation emitters arranged along a line, each emitter causing optical radiation to be emitted in substantially a common direction;

one or more lenses, positioned adjacent the emitters, so as to collimate the radiation emitted from each emitter and to generate a line of substantially parallel light beams, each beam being collimated in at least a cross-array direction substantially perpendicular to the plane defined by the line of emitters and the common direction, such that any relative positional deviations from linearity for the light beams in the cross-array direction with respect to their width in that direction, is smaller downstream of the lens(es) with respect to that at the emitters.

In accordance with the invention, one or more lenses are positioned adjacent the emitters. This provides a great advantage in that the lens(es) may be actually attached to the emitters themselves or at least to the light emitter bar. This attachment may be in a removeable or non-removeable manner, in the latter case involving for example an adhesive. A separate lens may be provided for each emitter, or alternatively a common elongate lens may be provided, deviated at each respective location along the emitter bar to correspond to deviations within the positions of the emitters.

When individual lenses are used, these are preferably mounted to one another, for example using an optically transparent adhesive. The refractive index of the adhesive is matched to the laser and lens to minimize reflections.

It should be understood that where optical radiation or light is described herein, this is intended to include both visible and non-visible radiation, including ultra-violet and infra-red radiation.

Preferably the lens (es) collimate the emitted beams in a direction within the plane defined by the emitter line and the common direction, and which is substantially perpendicular to the cross-array direction. In the case where individual lenses are provided, these also may be arranged so as to collimate the beam within the plane in a direction parallel to the line of the emitters. The invention is therefore advantageous over that described in for example U.S. Pat. No. 5,854,851 since the positioning of the lens(es) adjacent to the emitters provides a compact device in which the lens(es) effectively act as spectacles in a case where a microscopic gap exists between the emitters and the lens(es), or “contact lenses” in the situation where the lens(es) are mounted to the emitters themselves. The adjacent positioning of the lenses also provides for a substantial reduction in any alignment errors in the lenses themselves.

The invention also includes various methods of producing the radiation generating assembly described above, these depending upon the type of lens(es) used and whether a single line of radiation or a line of radiation spots is required.

Thus, in accordance with the second aspect of the present invention we provide a method of producing an optical radiation generating apparatus in accordance with the first aspect of the invention, the method comprising

arranging the said lens(es) in an initial position adjacent the emitters;

operating the emitters so as to produce the said corresponding collimated beams; and

adjusting the geometry and/or position of the lens(es) with alignment means such that each of the collimated beams of the emitters are substantially parallel.

This method therefore provides for the tailoring of the corrective optics to the particular radiation emitter bar in question. When a lens is provided for each emitter, these may be individually positioned and the associated emitter operated such that each beam is adjusted one at a time. Alternatively, each of the lenses can initially be placed in front of their corresponding emitters and then adjusted in any order. Preferably, adhesive is applied between the lenses so as to attach them together. The adhesive may be applied prior to the final adjustment of the geometry and/or position of the lens in question. This adhesive can therefore subsequently be cured for example by the application of ultra-violet light or by heat so as to set in the correct position and attach the lenses together.

Each lens is therefore preferably supported in an appropriate holder. In the case of the use of a single lens which extends across the line defined by the emitters, the alignment means is preferably operated to deform the parts of the lens adjacent any of the emitters which are out of alignment. The alignment means therefore may comprise the holder itself. Typically, following alignment, when the lens(es) are attached to the emitter bar, the method further comprises the step of subsequently performing this attachment. Alternatively, the attachment may occur prior to or during the performance of the alignment step.

In accordance with a third aspect of the present invention, a method of producing optical radiation generating apparatus according to the first aspect of the invention comprises:

determining the relative position of the emitters with respect to one another in the line;

calculating a lens geometry of one or more lenses so as to produce the said parallel collimated beams;

providing the said lens(es); and

positioning the said lens(es) adjacent the emitters.

In this case, the relative position of the emitters with respect to one another in the line is first determined. This may be performed by operating the emitters and monitoring the position of their respective radiation beams. Alternatively, a physical measurement of the relative emitter position can be performed by analysis of the front face of the radiation emitter bar.

Once the deviations in the respective positions have been determined, the corrective optics required can then be calculated. This can be performed using a computer model of the system or in more simple cases by geometric optics calculations. For example, in the case of a use of a single lens, certain constraints can be applied to the form of the corrective lens shape. One such restriction would be that the lens requires a common cross-sectional geometry and that the corrections merely comprise distortion of the lens at various parts away from linearity and yet lying within a common plane. This would effectively produce a lens similar to that described earlier as “distorted” using the alignment means. It is also contemplated that the results of the calculations or modelling could be used directly to control a manufacturing tool where a lens or a mould is cut from solid material. The cut surfaces could then be smoothed for example by heating or the use of some other means to melt the surface such as an electron beam. This method therefore allows for an exact lens prescription for each radiation emitter bar to be produced. Once manufactured, the lens(es) are then arranged adjacent the emitters as before.

In accordance with a fourth aspect of the present invention, optical radiation generating apparatus comprises:

an emitter bar comprising an array of optical radiation emitters arranged along a line, each emitter causing light to be emitted in substantially a common direction;

a radiation guide comprising two opposed radiation reflecting surfaces separated in a cross-array direction substantially perpendicular to the line of emitters, the surfaces being divergent with respect to one another from an input end of the guide arranged adjacent the emitters, to a distal output end, wherein in use optical radiation from the emitters enters the guide between the opposed surfaces and reflects from the surfaces so as to generate output beams at the output end, such that any relative positional deviations from linearity for the light beams in the cross-array direction with respect to their width in that direction, is smaller at the output end of the guide than at the emitters.

This provides another method of addressing the problems caused by deviations from linearity with the emitter array. Here the sides of the divergent beam emitted from the emitters is reflected off the internal opposed reflective surfaces or the guide, the surfaces being arranged in a divergent manner in the direction of travel of the radiation beam. The effect of this is again to reduce the relative displacements of the beams from the various emitters with respect to their overall width.

The guide may be formed from two angled mirrors, with an air gap between them. Alternatively the guide may be formed from a transparent material whereby light reflection occurs at the reflective surfaces by a total internal reflection effect.

In some cases, the reflective surfaces are arranged to be planar, whereas in others the guide is arranged to be deformed along a direction parallel to the line of emitters so as to accommodate positional deviations from linearity of those emitters. Preferably the emitters and guide are arranged such that the radiation from the emitters overlaps at the output end. This is advantageous in the production of a line of output radiation comprising the combined radiation from each of the beams. In this case the guide preferably further comprises two opposed reflective side surfaces which are arranged parallel to one another, each side surface connecting the opposed diversion surfaces. The surfaces therefore confine the combined beam of radiation in the direction defined by the line of emitters.

In accordance with a fifth aspect of the present invention optical radiation generation apparatus comprises:

an emitter bar comprising an array of optical radiation emitters arranged along a line, each emitter causing radiation to be emitted in substantially a common direction;

one or more lenses, positioned so as to receive the radiation from the emitters, and arranged to collimate the radiation emitted from each emitter into a beam, each beam being collimated in at least a cross-array direction substantially perpendicular to the plane defined by the line of emitters and the common direction;

one or more prisms positioned so as to receive and deflect the beams from the lens(es), wherein a transparent prism is provided for the beam of each emitter whose position deviates from the line defined by the emitter array, and wherein each prism is tilted such that the beams from the emitter array are substantially parallel downstream of the prism(s).

The use of a prism is advantageous since the input beam is collimated and therefore the prism will introduce no spherical aberrations in the beams in the cross-array direction. Typically the beam along the other axis is either collimated or slightly divergent and the amount of spherical aberration introduced along that axis is also insignificant. The tilt angles required and the angle defining the prismatic opposed surfaces are small, typically well below a degree such that chromatic aberrations over the bandwidth of the emitters will be significant. Such small angles will also lead to a little or no magnification in the cross-array direction.

The apparatus may further comprise a holder adapted to support the prism(s), the holder comprising an adjustment means allowing the angle of the prism(s) to be adjusted. A solid hinge mechanism of the type described in U.S. Pat. No. 6,166,759 is suitable. It provides good stability, precise movement and can be fixed after adjustment.

In accordance with a sixth aspect of the present invention, a method of producing optical radiation generation apparatus according to the fifth aspect of the invention comprises,

arranging the said prism(s) in an initial position;

operating the emitters so as to produce the said corresponding collimated beams; and

adjusting the angle of the prism(s) with alignment means such that each of the collimated beams of the emitters are substantially parallel.

In the case where more than one prism is provided, these may be attached to one another using an adhesive.

Some examples of optical radiation generation apparatus and methods of producing such apparatus are now described with reference to the accompanying drawings, in which:

FIG. 1 illustrates the magnification of emitter deviations in a known system;

FIG. 2 schematically shows the form and relative arrangement of output beams from a known emitter bar;

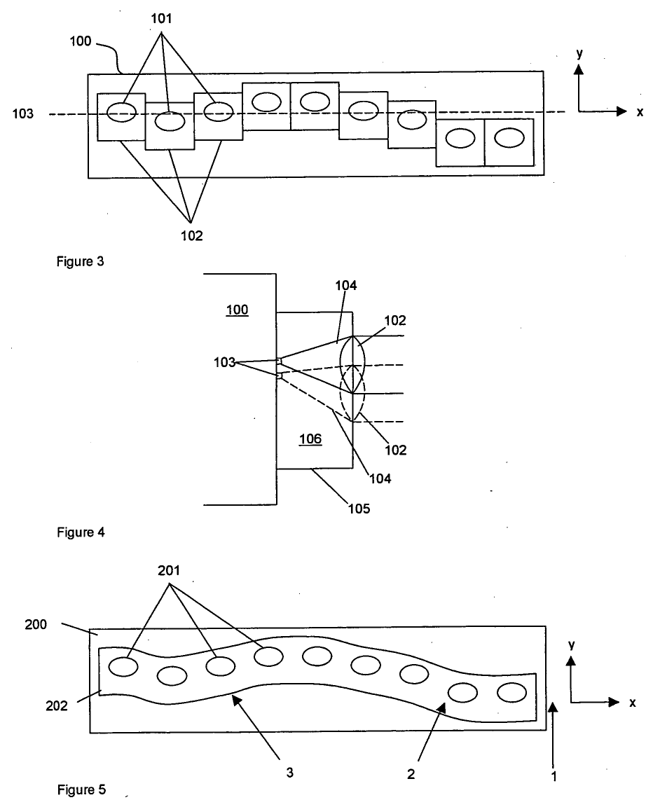

FIG. 3 illustrates the apparatus according to a first embodiment in which a lens is provided for each emitter;

FIG. 4 shows a second example in which a single distorted lens is used;

FIG. 5 shows the use of a divergent guide according to the invention;

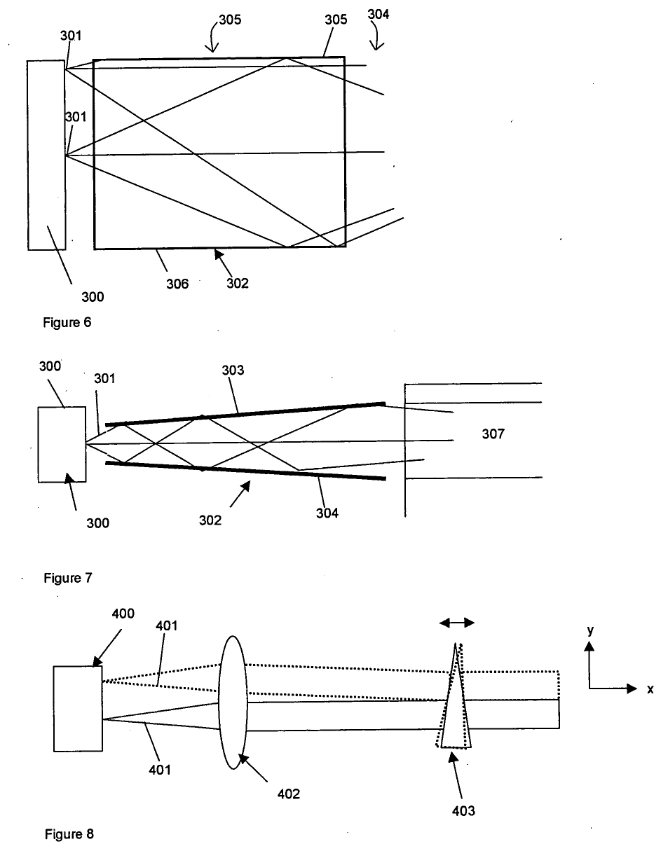

FIG. 6 shows the apparatus including the guide when viewed partly in section;

FIG. 7 illustrates the use of a prism to provide parallel collimated beams;

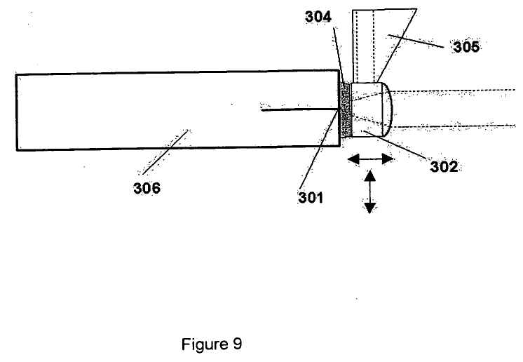

FIG. 8 is a view similar to FIG. 1 but of a further example; and, FIG. 9 illustrates schematically a lens alignment apparatus.

A first embodiment of the invention is shown in FIG. 3, here the radiation emitter bar is provided as a laser bar 100 which is shown schematically from the front in a similar manner to that described with reference to FIG. 2 earlier. The elliptical form of the beams 101 is also illustrated, these beams being emitted from corresponding emitters (not shown). In front of each of the respective emitters are positioned individual lenses 102 these lenses being arranged to collimate the light emitted from the emitters in each of the axes X and Y indicated in FIG. 3. Each of the lenses 102 is a high numerical aperture collimating lens these being of similar form to one another.

An example line 103 is shown passing along the length of the face of the laser bar 100 containing the emitters. This can be thought of as a line defining the line of emitters and it will be seen that a number of the emitters are not positioned along the Y axis centered upon this line 103. The displacement on the Y axis from this line represents the deviation from linearity and it is the effect of these deviations in the resultant emitted beams which are desired to be addressed.

FIG. 4 shows a view of the end of a laser bar containing the emitters when viewed from the side. Two emitters are shown at 103. The lenses 102 collimate the divergent beams 104 emitted by the emitters. Each of the lenses 102 is mounted in a front face of a support 105. The support is attached to the front of the laser bar 100. The region 106 between the emitters and the lenses 102, is filled with a transparent resin which also can act as an adhesive so as to secure the lenses to the front of the laser bar 100.

A thin layer of adhesive is also placed between the lenses as the array is built up. The position of each lenslet is adjusted with an external mechanism to provide a collimated parallel beam. The holder mechanism and lenses are then removed and the adhesive between the lenses is allowed to set. The glue could be a UV curing or thermally activated adhesive for example. The lens array can now be removed as a single element. This element is then aligned again to the laser bar and fixed into position. Fixing can be as part of a simple mechanism or by gluing to the laser bar. Thus a compact design can be achieved which is applicable to both laser bars and arrays.

A possible procedure for lens mounting is shown in FIG. 9. The lens 302 is held with a vacuum gripper 305 in front of the laser bar 306 which emits laser radiation. The lens 302 is moved in front of the laser emitter 301. The gap between emitter and lens is filled with liquid glue 304 and the lens is moved until the beam is collimated and is pointing perpendicular to the laser emitter 301. After the lens 302 is in position, UV radiation is used to harden the glue and to keep the lens 302 in place. Subsequently the gripper 205 is removed. This procedure is repeated for each emitter 301.

In a second embodiment illustrated in FIG. 5, a single elongate lens is provided to have a similar function to the description above in connection with the first embodiment. Here an emitter bar 200 is provided, again with emitted beams 201. The elongate lens is indicated at 202. It will be noted that this is deformed from linearity along its length. The lens has a constant cross-section as a function of the direction x and in use is deformed in the Y direction such that the centre of the lens at any point along the Y direction is substantially coincident with the centre of the emitter to which it is adjacent. The lens 202 may be placed in a holder and adjusted to take the form of the emitter displacements purely by a measurement of their relative positions. Alternatively, it may be positioned in its working position, and the emitters operated, the lens then being deformed for the respective emitters so as to produce the desired parallel collimated beam. Once the lens 202 has adopted the correct form it is adhered to the laser beam array 200.

The above embodiments have described the use of physical movements or distortion of the lenses so as to provide the desire collimated parallel beam. In a fourth embodiment, the relative positions of the emitters with respect to a line such as 103 in FIG. 3 are measured, or alternatively the positions of the respective emitter beams are similarly measured. These data are then used in association with a manufacturing tool so as to manufacture a lens which has a relative position along the line at any point showing deviations similar to those of the emitters. Therefore a “rod” lens similar to that shown in FIG. 5 at 202 may be machined, rather than using in-situ deformation. Once manufactured, this may be adhered to the front of the specific laser bar for which it was produced.

A further embodiment addressing the problems caused by deviations in emitter positions is shown in FIG. 6. FIG. 6 shows a laser bar 300 viewed from above. This is provided with various emitters on the front face. The beams arising from two such emitters are shown at 301. A tapered guide 302 is provided, this having an approximately rectangular section when viewed from above. This has upper 303 and lower 304 surfaces and side walls 305 and 306 as indicated in FIG. 6. It will be noted from FIG. 6 that the side walls 305 and 306 cause reflection of the light beams 301 from their surfaces. This allows mixing of the light from each of the emitters so as to produce a substantially uniform line of light (radiation) which emerges from the end of the guide 302. As can be seen from FIG. 7, which shows the apparatus partly in section, the upper and lower walls 303, 304 diverge as a function of distance along the beam propagation direction. These also have internal reflective surfaces which cause the light emitted from the emitters 301 to reflect as it travels along the guide in the propagation direction. As a result, due to the diverging upper and lower surfaces, the relative deviations in the positions of the emitters is reduced as a function as the beam width emerging from the far end of the guide 302.

It should be noted in this example that the guide is hollow and effectively a box having internal reflective surfaces. Due to the laws of refraction, this could also be provided as a transparent solid object, with the reflection at the surfaces being caused by total internal reflection (that is the material outside the surfaces being of lower refractive index). In this particular example, the light emerging from the far end of the guide is coupled into a waveguide 307. As will also be apparent from FIGS. 6 and 7, the length to width ratio of the guide 302 is substantial so as to allow for complete mixing of the beams prior to their emergence from the far end of the guide.

The guide may also be deformed across the line of emitters so as to compensate for any deviations of the positions of the laser emitters.

A further embodiment is shown in connection with FIG. 8 in which an emitter bar 400 provides respective light beams, of which two are showing at 401. These impinge upon a collimating lens 402 and this may be either a single lens or a number of lenses. Downstream of the lens 402 is provided an array of prisms 403. One prism is provided for each beam 401 as can be seen in FIG. 8, the upper beam and lower beams enter the respective prisms at an angle to one another. However, the prisms 403 are angled with respect to one another such that the beams exiting the prisms in each case are parallel with one another. Again, although of the parallel beams does not lie in a plane having a thickness equal to that of the beam width, nevertheless the deviations in the beam positions are again smaller with respective to their overall width in the y direction, that is in the cross-arraying direction, than at the position where the beams exiting the emitter.

The high numerical aperture (NA) collimating lens 402 is positioned and aligned to provide a collimated beam from the array of diode emitters 1. A lower NA lens array can be provided in the other axis to produce a collimated beam, or this axis can be allowed to expand to provide a uniform beam. This is not shown in FIG. 8 for simplicity.

The tilted prism array can be formed in three ways:
1) Using a tilting mechanism under each of the prisms, leading to a fully adjustable assembly.
2) If there is limited room the mechanism can be removed if the individual prisms are glued together to form a single element.
3) A similar arrangement to 2 can be produced if the prisms in option 2 are replicated using an appropriate setting liquid.

1. Radiation generating apparatus comprising:
an emitter bar comprising an array of optical radiation emitters arranged along a line, each emitter causing optical radiation to be emitted in substantially a common direction;
one or more lenses, positioned adjacent the emitters, so as to collimate the radiation emitted from each emitter and to generate a line of substantially parallel light beams, each beam being collimated in at least a cross-array direction substantially perpendicular to the plane defined by the line of emitters and the common direction, such that any relative positional deviations from linearity for the light beams in the cross-array direction with respect to their width in that direction, is smaller downstream of the said one or more lenses with respect to that at the emitters.

2. Apparatus according to claim 1 wherein the one or more lenses are attached to the emitters.

3. Apparatus according to claim 2, wherein the one or more lenses are attached to the emitters using an adhesive.

4. Apparatus according to claim 1, wherein a separate lens is provided for each emitter.

5. Apparatus according to claim 1, wherein a common lens is provided along the line of emitters.

6. Apparatus according to claim 1, wherein the said one or more lenses collimate the emitted light beams in a direction within the said plane and substantially perpendicular to the cross-array direction.

7. A method of producing optical radiation generating apparatus according to claim 1, comprising:
arranging the said one or more lenses in an initial position adjacent the emitters;
operating the emitters so as to produce the said corresponding collimated beams; and
adjusting the geometry and/or position of the said one more lenses with alignment means such that each of the collimated beams of the emitters are substantially parallel.

8. A method according to claim 7, wherein a lens is provided for each emitter and wherein adhesive is applied between the lenses to attach them together.

9. A method according to claim 7, wherein a single common lens is provided and wherein the alignment means is operated to deform parts of the lens according to the position of the corresponding emitter.

10. A method according to claim 7, wherein the said one more lenses are subsequently attached to the said emitter bar.

11. A method of producing optical radiation generating apparatus according to claim 1, comprising:
determining the relative position of the emitters with respect to one another in the line;
calculating a lens geometry of one or more lenses so as to produce the said parallel collimated beams;
providing the said one or more lenses; and
positioning the said lenses adjacent the emitters.

12. Optical radiation generation apparatus comprising:
an emitter bar comprising an array of optical radiation emitters arranged along a line, each emitter causing light to be emitted in substantially a common direction;
a radiation guide comprising two opposed radiation reflecting surfaces separated in a cross-array direction substantially perpendicular to the line of emitters, the surfaces being divergent with respect to one another from an input end of the guide arranged adjacent the emitters, to a distal output end, wherein in use optical radiation from the emitters enters the guide between the opposed surfaces and reflects from the surfaces so as to generate output beams at the output end, such that any relative positional deviations from linearity for the light beams in the cross-array direction with respect to their width in that direction, is smaller at the output end of the guide than at the emitters.

13. Apparatus according to claim 12, wherein the guide is formed from a transparent material whereby light reflection at the reflecting surfaces is caused by total internal reflection.

14. Apparatus according to claim 12, wherein the reflective surfaces are planar.

15. Apparatus according to claim 12, wherein the light guide is deformed along a direction parallel to the line of emitters so as to accommodate deviations from linearity in the positions of the emitters.

16. Apparatus according to claim 12, wherein the emitters and guide are arranged such that the light from the emitters overlaps at the output end.

17. Apparatus according to claim 16, wherein the guide further comprises two opposed reflective side surfaces arranged parallel to one another, each side surface connecting the opposed divergent surfaces.

18. Optical radiation generation apparatus comprising:
an emitter bar comprising an array of optical radiation emitters arranged along a line, each emitter causing radiation to be emitted in substantially a common direction;
one or more lenses, positioned so as to receive the radiation from the emitters, and arranged to collimate the radiation emitted from each emitter into a beam, each beam being collimated in at least a cross-array direction substantially perpendicular to the plane defined by the line of emitters and the common direction;
one or more prisms positioned so as to receive and deflect the beams from the said one or more lenses, wherein a transparent prism is provided for the beam of each emitter whose position deviates from the line defined by the emitter array, and wherein each prism is tilted such that the beams from the emitter array are substantially parallel downstream of the said one or more prisms, such that any relative positional deviations from linearity for the light beams in the cross-array direction with respect to their width in that direction, is smaller downstream of the said one or more prisms with respect to that at the emitters.

19. Apparatus according to claim 18, wherein the beams deflected by the prism are substantially parallel to the common direction.

20. Apparatus according to claim 18, further comprising a holder adapted to support the said one or more prisms, the holder comprising an adjustment means allowing the angle of the prisms to be adjusted.

21. A method of producing light generation apparatus according to claim 20, the method comprising:
arranging the said one or more prisms in an initial position;
operating the emitters so as to produce the said corresponding collimated beams; and
adjusting the angle of the said one or more prisms with alignment means such that each of the collimated beams of the emitters are substantially parallel.
